(19) United States
(12) Patent Application Publication
(10) Pub. No.: US 2026/0243304 A1
(43) Pub. Date: Aug. 20, 2026

(54) CAGE FOR A SPHERICAL ROLLER BEARING HAVING RETENTION FEATURE

(71) Applicant: AKTIEBOLAGET SKF, GOTEBORG (SE)

(72) Inventors: James M TULLY, Schwenksville, PA (US); Arne Lars Jonas KULLIN, Landvetter (SE)

(21) Appl. No.: 19/053,897

(22) Filed: Feb. 14, 2025

(51) Int. Cl. F16C 33/46

(52) U.S. Cl. CPC F16C 33/467

(57) ABSTRACT

A cage for a spherical roller bearing includes an annular spine having a centerline, two opposing axial ends, an inner radial end and an outer radial end and a plurality of cage bars extending axially from at least one axial end of the spine. The cage bars are spaced circumferentially apart about the centerline such that a plurality of pockets are defined between each pair of adjacent bars. Each bar has an inner axial end connected with the spine and a free, outer axial end, an axial opening of each pocket for receiving one of the rolling elements being defined between the outer axial ends of the pair of adjacent bars defining the pocket. Each cage bar is configured to prevent axial displacement of a rolling element disposed within a pocket partially defined by the cage bar in a direction away from the spine.

### BACKGROUND OF THE INVENTION

The present invention relates to bearings, and more particularly to cages for spherical bearings.

Spherical bearings are well known and typically include an inner ring with two angled inner raceways, an outer ring with a partially spherical outer raceway and two sets of barrel-shaped rolling elements which each roll along a separate one of the inner raceways and both roll along the common outer raceway. With this structure, the inner and outer rings are pivotable with respect to each other along the bearing central axis, such that the bearing can accommodate misalignment between an inner shaft and an outer housing rotatably coupled by the bearing.

To maintain spacing between the rolling elements and to ensure that the elements continue to circulate in unloaded sections of the bearing, spherical bearings typically include an annular cage with a plurality of pockets each receiving one rolling element. The rolling elements are typically installed by inserting each rolling element into a separate pocket through an axial opening into the pocket. As one set of rolling elements is first installed into one side of the cage and then the cage and inner ring are turned or rotated to allow installation of the rolling elements into the other side of the cage, the inner ring is typically formed with a flange or other structural feature to retain one set of rolling elements after installation. Such retention structure on the inner ring leads to an increased cost in the manufacturing of the ring.

### SUMMARY OF THE INVENTION

In an aspect, the present invention is a cage for a spherical roller bearing including a plurality of barrel-shaped rolling elements, each barrel-shaped rolling element having two opposing axial ends and a curved outer circumferential surface with a minimum diameter at each axial end and a maximum diameter at a center of the rolling element. The cage comprises an annular spine having a centerline, two opposing axial ends, an inner radial end and an outer radial end. A plurality of cage bars extend axially from at least one axial end of the spine and are spaced circumferentially apart about the centerline such that a plurality of pockets are defined between each pair of adjacent bars. Each bar has an inner axial end connected with the spine and a free, outer axial end, an axial opening of each pocket for receiving one of the rolling elements being defined between the outer axial ends of the pair of adjacent bars defining the pocket. Further, each cage bar is configured to prevent axial displacement of a rolling element disposed within a pocket partially defined by the cage bar in a direction away from the spine.

Preferably, each cage bar has opposing first and second concave guide surfaces each extending axially between the inner and outer axial ends of the cage bar. Each one of the plurality of pockets is partially defined between a pair of facing guide surfaces including the first guide surface of one of plurality of cage bars and the second guide surface of an adjacent one of the plurality of cage bars. Further, each one of the first and second guide surfaces of each pair of facing guide surfaces has a central surface section, the two central surface sections being spaced apart by a first distance greater than the maximum diameter of the rolling elements, and a retention surface section located axially between the central surface section and the outer axial end of the cage bar. The two retention surface sections are spaced apart by a second distance less than the rolling element maximum diameter. As such, the two retention surface sections are engageable with a rolling element disposed between the pair of facing guide surfaces to prevent axial displacement of the rolling element outwardly from the pocket defined between the pair of facing guide surfaces.

More specifically, each retention surface section of each pair of facing guide surfaces is preferably engageable with a portion of the outer circumferential surface of the rolling element located between the center and one axial end. Preferably, each one of the first and second concave guide surfaces of each cage bar extends generally semi-elliptically from the inner axial end of the cage bar to the outer axial end of the cage bar such that each one of the two retention surface sections of each pair of facing guide surfaces extend generally circumferentially toward the other one of the two retention surfaces of the pair of facing guide surfaces.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a bearing including a cage in accordance with the present invention;

FIG. 2 is a perspective view of the present cage;

FIG. 3 is a broken-away, enlarged perspective view of a portion of the present cage;

FIG. 4 is a broken-away, enlarged radially inner plan view of a portion of the cage;

FIG. 5 is a more enlarged view of a portion of FIG. 4; and

FIG. 6 is a broken-away perspective view of the cage, shown with several rolling elements installed within the cage.

### DETAILED DESCRIPTION OF THE INVENTION

Certain terminology is used in the following description for convenience only and is not limiting. The words "inner", "inwardly" and "outer", "outwardly" refer to directions toward and away from, respectively, a designated centerline or a geometric center of an element being described, the particular meaning being readily apparent from the context of the description. Further, as used herein, the words "connected" and “coupled” are each intended to include direct connections between two members without any other members interposed therebetween and indirect connections between members in which one or more other members are interposed therebetween. The terminology includes the words specifically mentioned above, derivatives thereof, and words of similar import.

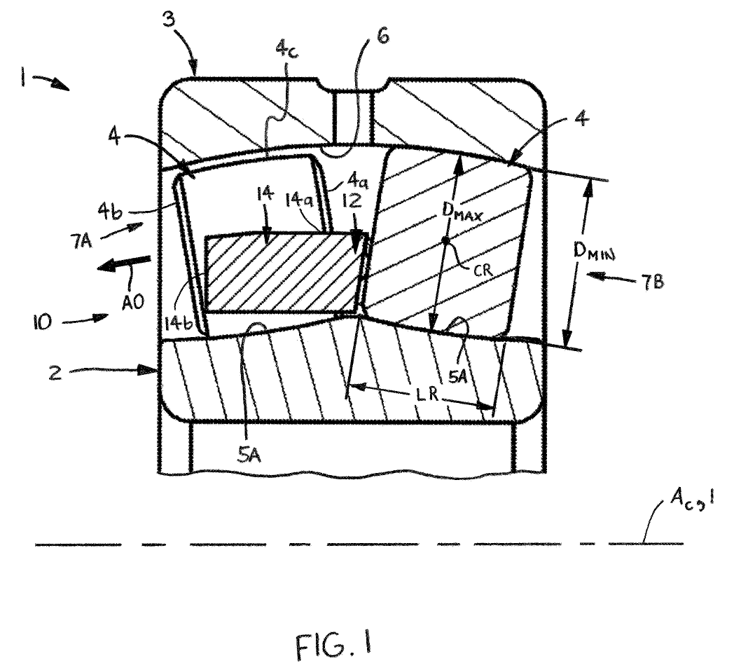

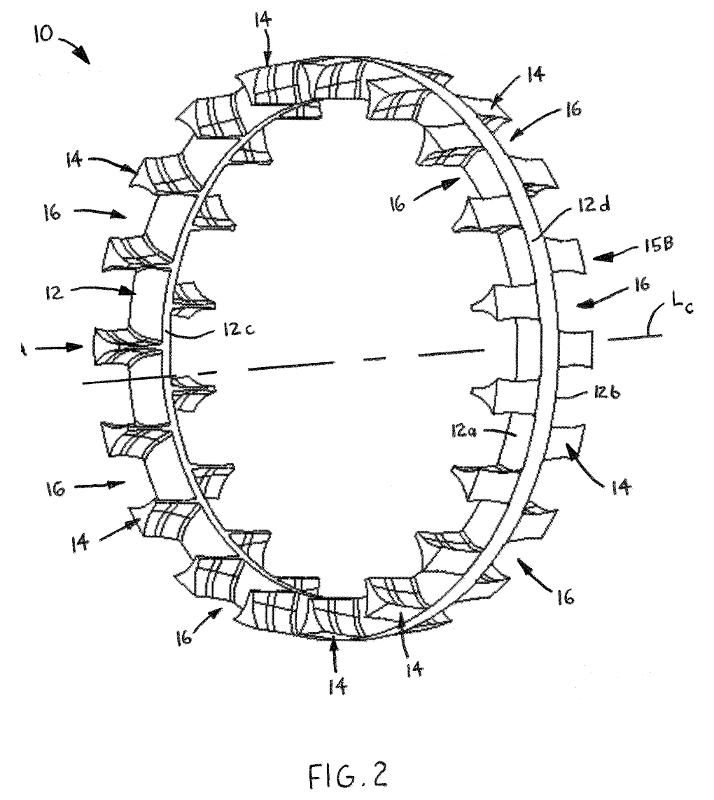

Referring now to the drawings in detail, wherein like numbers are used to indicate like elements throughout, there is shown in FIGS. 1-6 a cage 10 for a spherical roller bearing 1 including an inner ring 2, an outer ring 3 and a plurality of barrel-shaped rolling elements 4, at least one of the rings 2, 3 being rotatable about a central axis A_{C}. The bearing 1 is preferably formed as a typical spherical roller bearing in which the inner ring 2 has two curved and inclined raceways 5A, 5B each facing away from a center (not indicated) of the inner ring 3 and the outer ring 3 has a single outer raceway 6 formed partially spherical. Two rows 7A, 7B of the barrel-shaped rolling elements 4 are each disposed upon a separate inner raceway 5A, 5B, respectively, and are both rollable upon the common outer raceway 6. Each barrel-shaped rolling element 4 has two opposing, inner and outer axial ends 4a, 4b (i.e., “inner” and “outer” when installed in the cage 10) and a curved outer circumferential surface 4c with a minimum diameter D_{MIN} at each axial end 4a, 4b and a maximum diameter D_{MAX} at a center CR of the rolling element 4, as indicated in FIG. 1. The cage 10 is provided to both circumferentially separate each rolling element 4 within the two rows 7A, 7B and to drive rotation of the elements 4 in unloaded sections of the bearing 1. Basically, the cage 10 includes a central annular spine 12 and at least one and preferably two rows of cage bars 14, each cage bar 14 being configured to axially retain the rolling elements 4, as described in detail below.

More specifically, the annular spine 12 has a centerline L_{C}, two opposing axial ends 12a, 12b, an inner radial end 13 and an outer radial end 14. A plurality of cage bars 14 extend axially from at least one and preferably both axial ends 12a, 12b of the spine 12 and are spaced circumferentially apart about the centerline L_{C}. As such, a plurality of pockets 16 are defined between each pair of adjacent bars 14. Preferably, the cage 10 includes a first set of cage bars 15A extending axially from one axial end 12a of the spine 12 and a second set of cage bars 15B extending axially from the other axial end 12b of the spine 12, the two sets 15A, 15B preferably being circumferentially staggered about the centerline L_{C}.

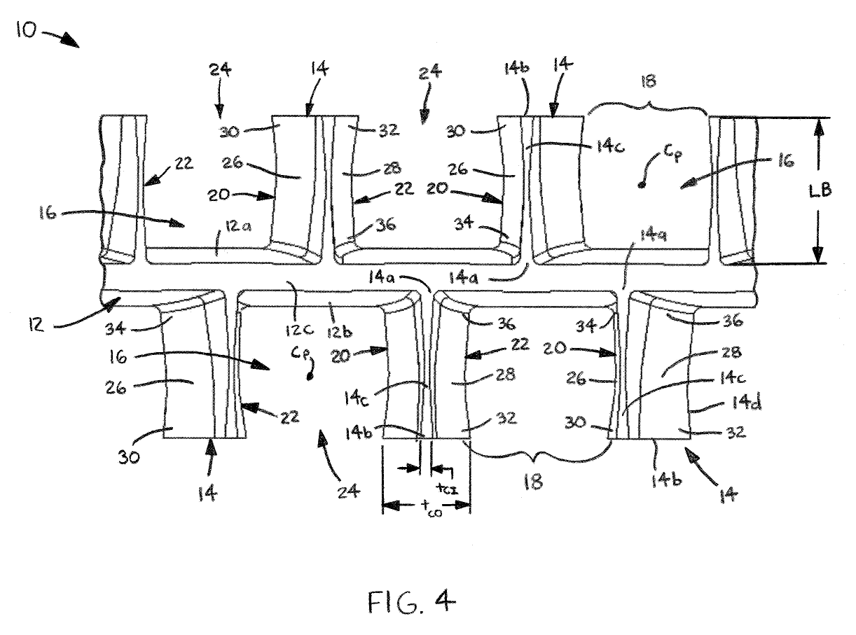

Further, each cage bar 14 has an inner axial end 14a connected with the spine 12 and a free, outer axial end 14b, an axial length LB of the bar 14 being defined between the two ends 14a, 14b. An axial opening 18 of each pocket 16 for receiving one of the rolling elements 4 is defined between the outer axial ends 14b of the pair of adjacent bars 14 defining the particular pocket 16. Preferably, the axial length LB (FIG. 4) of each cage bar 14 is less than an axial length LR (FIG. 1) of each rolling element 4, such that each rolling element 4 extends through the opening 18 of the associated pocket 16 after assembly of the bearing 1. However, the cage bars 14 may alternatively be formed having substantially the same length as, or even be longer than, the rolling elements 4.

Furthermore, each cage bar 14 is configured to prevent axial displacement of a rolling element 4 that is disposed within a pocket 16 partially defined by the cage bar 14 in a direction AO (FIG. 1) away from the spine 12. Preferably, the axial retention of the rolling elements 4 is provided by the specific shape and structure of the guide surfaces 20, 22 of each cage bar 14, as described in detail below. However, axial retention of the rolling elements 4 may also be provided by any other appropriate structure or mechanism, such as for example, by means of a separate stop member attached to each cage bar 14 and engageable with a proximal one of the rolling elements 4, etc.

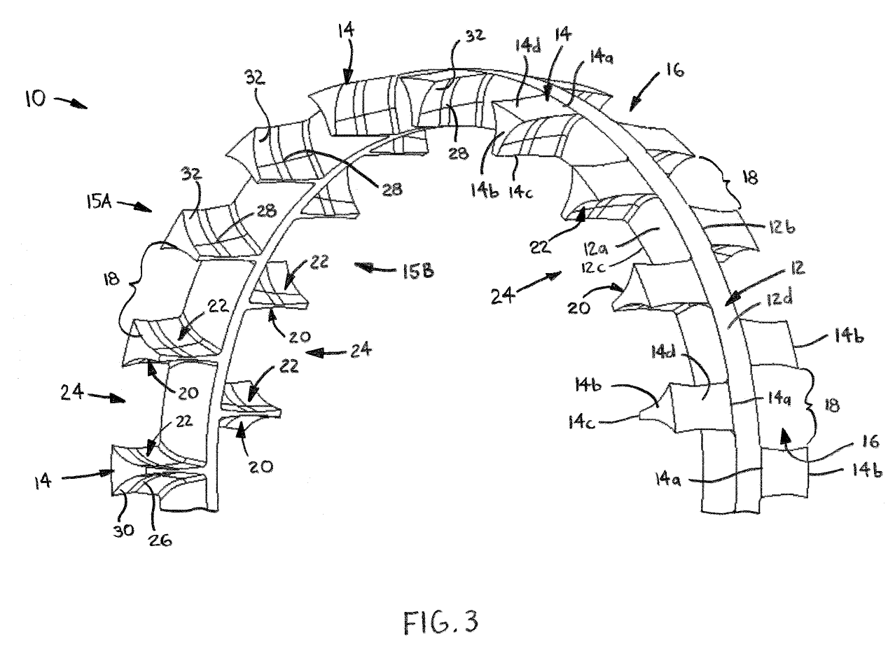

Referring to FIGS. 3-5, each cage bar 14 has opposing first and second concave guide surfaces 20, 22 each extending axially between the inner and outer axial ends 14a, 14b of the cage bar 14. As such, the two guide surface 20, 22 of a single cage bar 14 face in opposing circumferential directions. Each one of the plurality of pockets 16 is partially defined between a pair 24 of facing guide surface 20/22 including the first guide surface 20 of one of plurality of cage bars 14 and the second guide surface 22 of an adjacent one of the plurality of cage bars 14. Further, each guide surface 20, 22 is sized and shaped so as to allow the rolling element 4 disposed within the pocket 16 defined between the two surfaces 20, 22 to roll without restriction from the cage bars 14 once fully seated within the pocket 16.

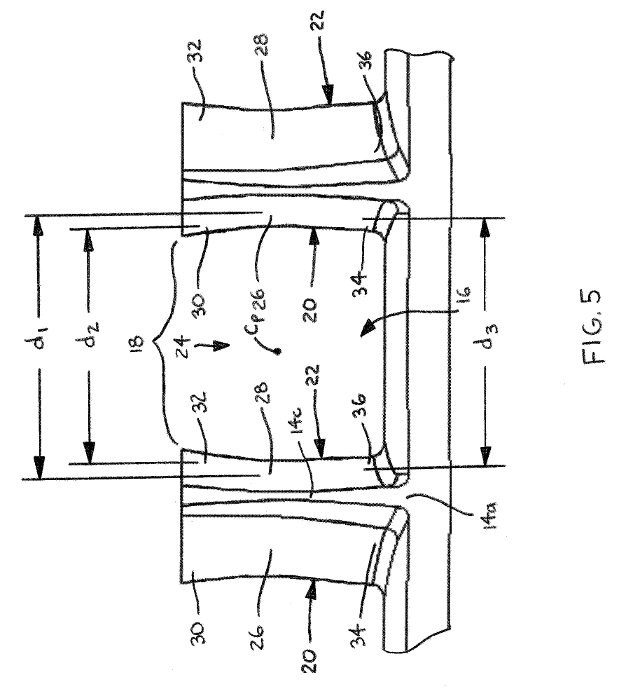

As best shown in FIGS. 4 and 5, each one of the first and second guide surfaces 20, 22 of each pair 24 of facing guide surfaces 20/22 has a central surface section 26, 28, respectively. The two central surface sections 26, 28 are spaced apart by a first distance d₁greater than the maximum diameter D_{MAX} of the rolling elements 4 and are located so as to be positioned adjacent to the center C_{R} of the outer surface 4c of the rolling element 4 disposed between the guide surfaces 20, 22. Further, each concave guide surface 20, 22 also has a retention surface section 30, 32, respectively, located axially between the central surface section 26, 28, respectively, and the outer axial end 14b of the cage bar 14 providing each guide surface 20 or 22. The two retention surface sections 30, 32 of each pair 24 of facing guide surfaces 20/22 are spaced apart by a second distance d₂ less than the rolling element maximum diameter D_{MAX}, and thus less than the first distance d₁ between the central surface sections 26, 28.

As such, the two retention surface sections 30, 32 are located so as to be engageable with the rolling element 4 disposed between the pair 24 of facing guide surfaces 20/22 to prevent axial displacement of the rolling element 4 outwardly from the specific pocket 16 defined between the pair 24 of facing guide surfaces 20/22. Specifically, each retention surface section 30, 32 of each pair 24 of facing guide surfaces 20/22 is engageable with a portion of the outer circumferential surface 4c of the rolling element 4 that is located between the center CR and the outer axial end 4b. In other words, as the circumferential spacing between the retention surface sections 30, 32, i.e., the second distance d₂, is less than the maximum diameter D_{MAX} of each rolling element 4, any axial displacement of the rolling element 4 in the axially outward direction AO will cause the rolling element outer surface 4c to wedge between the retention surface sections 30, 32 and thereby prevent any further axial displacement.

As the present cage 10 provides retention of the rolling elements 4 during assembly of the bearing 1, the bearing inner ring 2 may formed without a flange or other structural feature to retain the rolling elements 4 prior to swiveling closed the bearing 1. Thus, the simplified structure of the inner ring 2 provides a reduction in manufacturing costs. Having described the basic features of the cage 10 of the present invention above, these and additional aspects of the cage construction are disclosed below.

Referring again to FIGS. 4 and 5, each one of the first and second concave guide surfaces 20, 22 of each cage bar 14 extends preferably generally semi-elliptically from the inner axial end 14a of the cage bar 14 to the outer axial end 14b of the cage bar 14. As such, each one of the two retention surface sections 30, 32 of each pair 24 of facing guide surfaces 20/22 is generally curved and extends generally circumferentially toward the other one of the two retention surfaces 32, 30 of the pair 24 of facing guide surfaces 20/22. However, the retention surface sections 30, 32 may each have any other appropriate shape, such as generally flat or having a different curvature than the remainder of the guide surface 20, 22

Further, each one of the first and second concave guide surfaces 20, 22 of each cage bar 14 also has an axially inner surface section 34, 36, respectively, adjacent to the inner axial end 14a of the cage bar 14. The axially inner surface sections 34, 36 of each pair 24 of facing guide surfaces 20/22 are spaced apart by a third distance d₃ that is greater than the minimum diameter D_{MIN} of the rolling elements 4 and less than the first distance d₁. As such, at least certain circumferential cross-sections of each pair of facing guide surface 20, 22 generally follow the profile of the outer surface 4c of the rolling elements 4. Preferably, each guide surface 20, 22 is formed substantially continuously so as to extend as a continuous semi-ellipse in the axial direction from the cage bar inner axial end 14a to the cage bar outer axial end 14b.

Although one presently preferred contour for each of the concave guide surfaces 20, 22 are depicted in the drawing figures, each guide surface 20, 22 may have any appropriate shape or contour, have a number of discrete segments (i.e., either generally flat or curved), and/or be formed with any appropriate spacing distance between facing sections of each pair 24, as long as the retention surface sections 30, 32 are located axially between the central surface section 26, 28 and the outer axial ends 14b of the cage bars 14 and are spaced apart by a distance less than the maximum diameter D_{MAX} of the rolling elements 4. For example, Further, the retention surface sections 30, 32 are preferably located radially outwardly relative to the central surface sections 26, 28, but with another guide surface contour, the pairs of surface sections 26/30 and 28/32 may be located at least generally radially aligned or the retention surfaces 30/32 may be located radially inwardly of the central surface sections 26, 28 (no alternatives shown).

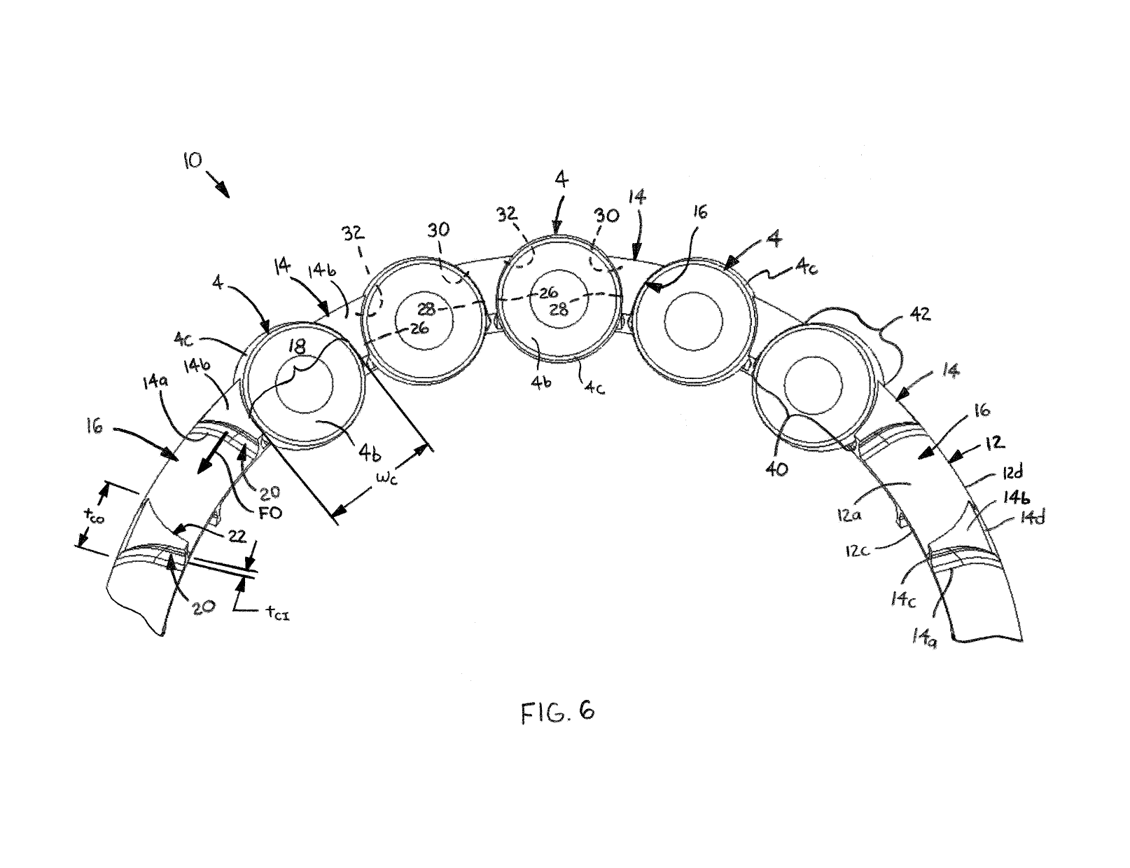

Referring to FIGS. 3-6, each one of the cage bars 14 also has an inner radial end 14c, an outer radial end 14d and generally wedge-shaped radial cross-sections. Each one of the first and second guide surfaces 20, 22 extend radially between the inner radial end 14c and the outer radial end 14d, and preferably generally converge toward each other at the inner end 14c while diverging away from each toward the outer radial end 14d. As a result, the outer radial end 14d has a circumferential thickness t_{CO} greater than a circumferential thickness t_{CI} of the inner radial end 14d, as indicated in FIG. 6.

Referring particularly to FIG. 6, each pocket 16 has an inner clearance window 40 defined between the inner radial ends 14c of each pair of adjacent cage bars 14 and an outer clearance window 42 defined between the outer radial ends 14d of each pair of adjacent bars 14. With this structure, radially outer sections of the rolling elements 4 project through the outer window 42 to engage with the outer race 6 and radially inner sections of each rolling element 4 project through the inner window 40 to engage with the inner race 5A or 5B. Due to the greater circumferential thickness t_{CO} of the radial outer ends 14d of the cage bars 14, each outer window 42 has a circumferential width (not indicated) that is substantially less than the circumferential width of each inner window 40, and less than the minimum diameter D_{MIN} of the rolling elements 4. As such, the outer radial ends 14c of the cage bars 14 also function to prevent radially outward displacement of the rolling elements 4, particularly during assembly into the cage 10 prior to installation of the outer ring 3.

As indicated in FIG. 6, each cage bar 14 is deflectable circumferentially about the inner axial end 14a of the bar 14 when an “opening” force FO is applied in the circumferential direction, preferably proximal to the bar outer axial end 14b, so as to temporarily increase the circumferential width w_{C} of the opening 18 defined between the outer axial end 14b of the bar 14 and the outer axial end 14b of an adjacent bar 14. Such deflection of the cage bar(s) 14 and increase in the opening width w_{C} allow a rolling element 4 to displace axially through the axial opening 18 of the pocket 16 defined between the two adjacent cage bars 14, either during installation or removal of the rolling elements 4. Preferably, the cage 10 is formed of a metallic material, and most preferably formed of a machined metallic material, for example brass, bronze, aluminum, low carbon steel, etc., such that the cage bars 14 are deflectable due to the inherent elastic nature of metals. However, the cage 10 of the present invention may be formed of any appropriate material (e.g., a rigid polymer such as polyamide) and in any appropriate process (e.g., additive manufacturing).

With the cage 10 of the present invention, assembly of the bearing 1 is facilitated while simplifying the fabrication of the bearing inner ring 2. Specifically, the bearing inner ring 2 may be formed without any flange or other structure for retaining the bearing rolling elements 4 during assembly, which also reduces manufacturing costs. Instead, with the cage 10 disposed about the inner ring 2, all of the rolling elements 4 of one row 7A or 7B are each installed into a separate one of the pockets 16 defined between one row 15A or 15B of the cage bars 14, specifically by deflecting one or both cage bars 14 and inserting the rolling element 4 through the opening 18 into the pocket 16 until the inner axial end 4a is adjacent to the spine 12. Once all of the elements 4 of the row 7A or 7B are installed, a subassembly consisting of the inner ring 2, the cage 10 and the one row of elements 7A or 7B may be turned or rotated to provide access to the other row of cage bars 15B, 15A, while the retention surface sections 30, 32 of the cage bars 14 of the other row 15B, 15A prevent the installed rolling elements 4 from falling out of the pockets 26. Thus, there is no need to form a retention flange or other structure on the inner ring 2.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A cage for a spherical roller bearing including a plurality of barrel-shaped rolling elements, each barrel-shaped rolling element having two opposing axial ends and a curved outer circumferential surface with a minimum diameter at each axial end and a maximum diameter at a center of the rolling element, the cage comprising:
an annular spine having a centerline, two opposing axial ends, an inner radial end and an outer radial end; and
a plurality of cage bars extending axially from at least one axial end of the spine and spaced circumferentially apart about the centerline such that a plurality of pockets are defined between each pair of adjacent bars, each bar having an inner axial end connected with the spine and a free, outer axial end, an axial opening of each pocket for receiving one of the rolling elements being defined between the outer axial ends of the pair of adjacent bars defining the pocket and each cage bar being configured to prevent axial displacement of a rolling element disposed within a pocket partially defined by the cage bar in a direction away from the spine.

2. The cage as recited in claim 1, wherein:
each cage bar has opposing first and second concave guide surfaces each extending axially between the inner and outer axial ends of the cage bar;
each one of the plurality of pockets is partially defined between a pair of facing guide surfaces including the first guide surface of one of plurality of cage bars and the second guide surface of an adjacent one of the plurality of cage bars; and
each one of the first and second guide surfaces of each pair of facing guide surfaces has a central surface section, the two central surface sections being spaced apart by a first distance greater than the maximum diameter of the rolling elements, and a retention surface section located axially between the central surface section and the outer axial end of the cage bar, the two retention surface sections being spaced apart by a second distance less than the rolling element maximum diameter such that the two retention surface sections are engageable with a rolling element disposed between the pair of facing guide surfaces to prevent axial displacement of the rolling element outwardly from the pocket defined between the pair of facing guide surfaces.

3. The cage as recited in claim 2, wherein each retention surface section of each pair of facing guide surfaces is engageable with a portion of the outer circumferential surface of the rolling element located between the center of the rolling element and one axial end of the rolling element.

4. The cage as recited in claim 2, wherein each one of the first and second concave guide surfaces of each cage bar extends generally semi-elliptically from the inner axial end of the cage bar to the outer axial end of the cage bar such that each one of the two retention surface sections of each pair of facing guide surfaces extend generally circumferentially toward the other one of the two retention surfaces of the pair of facing guide surfaces.

5. The cage as recited in claim 2, wherein each one of the first and second concave guide surfaces of each cage bar has an axially inner surface section adjacent to the inner axial end of the cage bar, the axially inner surface sections of each pair of facing guide surfaces being spaced apart by a third distance greater than the minimum diameter of the rolling elements and less than the first distance.

6. The cage as recited in claim 2, wherein each one of the cage bars has an inner radial end, an outer radial end and generally wedge-shaped radial cross-sections, each one of the first and second guide surfaces extending radially between the inner radial end and the outer radial end, the outer radial end having a circumferential thickness greater than a circumferential thickness of the inner radial end.

7. The cage as recited in claim 1, wherein each cage bar is deflectable circumferentially about the inner axial end of the bar so as to increase a circumferential width of the opening defined between the outer axial end of the cage bar and the outer axial end of an adjacent cage bar so as to allow a rolling element to displace axially through the opening.

8. The cage as recited in claim 7, wherein the cage is formed of a metallic material.

9. The cage as recited in claim 1, wherein each cage bar has an axial length between the inner axial end and the outer axial end, the axial length of each cage bar being less than an axial length of each rolling element.

10. The cage as recited in claim 1, wherein the cage includes a first set of cage bars extending axially from one axial end of the spine and a second set of cage bars extending axially from the other axial end of the spine.

11. The cage as recited in claim 1, wherein the cage is formed of a machined metallic material.

12. A cage for a spherical roller bearing including a plurality of barrel-shaped rolling elements, each barrel-shaped rolling element having two opposing axial ends and a curved outer circumferential surface with a minimum diameter at each axial end and a maximum diameter at a center of the rolling element, the cage comprising:
an annular spine having a centerline, two opposing axial ends, an inner radial end and an outer radial end; and
a plurality of cage bars extending axially from at least one axial end of the spine and spaced circumferentially apart about the centerline such that a plurality of pockets are defined between each pair of adjacent bars, each cage bar having an inner axial end connected with the spine and a free, outer axial end, an axial opening of each pocket for receiving one of the rolling elements being defined between the outer axial ends of the pair of adjacent bars defining the pocket, each cage bar further having opposing first and second concave guide surfaces each extending axially between the inner and outer axial ends of the cage bar;
wherein each one of the plurality of pockets is partially defined between a pair of facing guide surfaces including the first guide surface of one of plurality of cage bars and the second guide surface of an adjacent one of the plurality of cage bars; and
wherein each one of the first and second guide surfaces of each pair of facing guide surfaces has a central surface section, the two central surface sections being spaced apart by a first distance greater than the maximum diameter of the rolling elements, and a retention surface section located axially between the central surface section and the outer axial end of the cage bar, the two retention surface sections being spaced apart by a second distance less than the rolling element maximum diameter such that the two retention surface sections are engageable with one of the plurality of rolling elements disposed between the pair of facing guide surfaces to prevent axial displacement of the one rolling element outwardly from the pocket defined between the pair of facing guide surfaces.

13. The cage as recited in claim 12, wherein each retention surface section of each pair of facing guide surfaces is engageable with a portion of the outer circumferential surface of the rolling element located between the center and one axial end.

14. The cage as recited in claim 12, wherein each one of the first and second concave guide surfaces of each cage bar extends generally semi-elliptically from the inner axial end of the cage bar to the outer axial end of the cage bar such that each one of the two retention surface sections of each pair of facing guide surfaces extend generally circumferentially toward the other one of the two retention surfaces of the pair of facing guide surfaces.

15. The cage as recited in claim 12, wherein each one of the first and second concave guide surfaces of each cage bar has an axially inner surface section adjacent to the inner axial end of the cage bar, the axially inner surface sections of each pair of facing guide surfaces being spaced apart by a third distance greater than the minimum diameter of the rolling elements and less than the first distance.

16. The cage as recited in claim 12, wherein each one of the cage bars has an inner radial end, an outer radial end and generally wedge-shaped radial cross-sections, each one of the first and second guide surfaces extending radially between the inner radial end and the outer radial end, the outer radial end having a circumferential thickness greater than a circumferential thickness of the inner radial end.

17. The cage as recited in claim 12, wherein each cage bar is deflectable circumferentially about the inner axial end of the bar so as to increase a circumferential width of the opening defined between the outer axial end of the cage bar and the outer axial end of an adjacent cage bar so as to allow a rolling element to displace axially through the opening.

18. The cage as recited in claim 12, wherein each cage bar has an axial length between the inner axial end and the outer axial end, the axial length of each cage bar being less than an axial length of each rolling element.

19. The cage as recited in claim 12, wherein the cage includes a first set of cage bars extending axially from one axial end of the spine and a second set of cage bars extending axially from the other axial end of the spine.

20. The cage as recited in claim 12, wherein the cage is formed of a machined metallic material.
